(19) United States
(12) Patent Application Publication
(10) Pub. No.: US 2025/0041898 A1
(43) Pub. Date: Feb. 6, 2025

(54) TWO-DIMENSIONAL OR THREE-DIMENSIONAL NANOCUBE SELF-ASSEMBLED STRUCTURE, AND PREPARATION METHOD THEREOF

(71) Applicants: SEOUL NATIONAL UNIVERSITY R&DB FOUNDATION, Seoul (KR); BIONANO HEALTH GUARD RESEARCH CENTER, Daejeon (KR)

(72) Inventors: Jwa-Min NAM, Seoul (KR); Yeon Hee LEE, Seoul (KR); Seungsang CHA, Seoul (KR); Yuna KWAK, Seoul (KR)

(21) Appl. No.: 18/720,325

(22) PCT Filed: Dec. 16, 2022
(86) PCT No.: PCT/KR2022/020638

§ 371 Date: Jun. 14, 2024

(30) Foreign Application Priority Data
Dec. 16, 2021 (KR) 10-2021-0180921

(51) Int. Cl. B05D 7/14

(52) U.S. Cl. CPC B05D 7/144

(57) ABSTRACT

The present invention relates to a method for preparing a two-dimensional or three-dimensional nanocube self-assembled structure and a two-dimensional or three-dimensional nanocube self-assembled structure prepared by the preparation method and, more specifically, to a two-dimensional or three-dimensional nanocube self-assembled structure which has uniform and regular nanogaps and high crystallinity and thus has high optical utilization.

### TECHNICAL FIELD

The present invention relates to a two-dimensional or three-dimensional nanocube self-assembly and a preparation method thereof.

### BACKGROUND ART

Plasmonic nanostructures, which exhibit localized surface plasmon resonance (LSPR), have distinctive characteristics and applications in various fields, such as sensing, imaging, diagnosis, therapies, and catalysts. Among the techniques for creating such nanostructures, a bottom-up manner of assembling manufactured nanoparticles can access small-scale structures at the molecular level of several nanometers or less, which cannot be accessed by a top-down manner. This leads to high usability, and thus, related conventional research has been actively conducted. For instance, Korean Patent Application No. KR 10-2018-0076446 A discloses gold multi-pod nanoparticles.

A plasmonic nanoparticle self-assembly method, which is one of the representative bottom-up methods, involves designing nanoparticles as units to spontaneously assemble into a specific pattern, and this method has been used to develop structures with various patterns and materials. In these nanoparticle assembled structures, nano-sized spaces created among particles are particularly attracting attention. In these spaces called plasmonic nanogaps, an electric field that is strongly enhanced by plasmon resonance is formed, and it is known that various phenomena, such as enhancement of optical signals and improvement in catalytic effects, occur inside the gaps. The electromagnetic field enhancement is generally more advantageous in smaller sizes up to one nanometer and responds to size and shape very sensitively, necessitating precise structure control.

However, most self-assembly techniques further required a complex surface modification process, such as exchange, change, and substitution of a capping agent, and this process had limitations, such as the addition of process steps, the loss of units during surface modification, and the restriction on the minimum size of nanogaps due to the size limitation of the capping agent.

Under this background, the present applicant conducted intensive efforts to solve the problems, and as a result, the present applicant established a preparation method capable of producing a two-dimensional or three-dimensional nanocube self-assembly without the restriction of the size and sharpness of units while regular and modifiable nanopatterns can be simply formed by merely using a depletant and nanoparticles not subjected to additional surface modification, and thus completed the present application.

### DISCLOSURE

### Technical Problem

An aspect of the present invention is to provide a method for preparing a two-dimensional or three-dimensional self-assembly, wherein the dimension and structure of a nanocube self-assembly formed by controlling the depletion force of the self-assembly formation substrate-unit, the method comprising: (a) applying, to a self-assembly formation substrate, a first solution comprising a surfactant and a depletant and a second solution comprising metal nanocube units; and (b) performing aging so that the metal nanocubes assemble to form a two-dimensional or three-dimensional nanocube self-assembly.

Another aspect of the present invention is to provide a two-dimensional or three-dimensional nanocube self-assembly produced by the preparation method.

### Technical Solution

The present application will be specifically described as follows. Each description and embodiment disclosed in the present application may also be applied to other descriptions and embodiments. That is, all combinations of various elements disclosed in the present application fall within the scope of the present application. Furthermore, the scope of the present application is not limited by the specific description below. Throughout the overall specification, many papers and patent documents are referenced and their citations are provided. The disclosures of cited papers and patent documents are entirely incorporated by reference into the present specification, and the level of the technical field within which the present disclosure falls and details of the present disclosure are explained more clearly.

In accordance with an aspect of the present application, there is provided a method for preparing a two-dimensional or three-dimensional self-assembly, comprising: (a) applying, to a self-assembly formation substrate, a first solution comprising a surfactant and a depletant and a second solution comprising metal nanocube units; and (b) performing aging so that the metal nanocubes assemble to form a two-dimensional or three-dimensional nanocube self-assembly.

The present invention is based on the establishment that the dimension and structure of a finally formed nanocube self-assembly can be controlled by controlling the depletion force of self-assembly formation substrate-unit. Accordingly, an aspect of the present invention is to provide a method for preparing a two-dimensional or three-dimensional plasmonic nanocube self-assembly with accurate and uniform nanogaps of a predetermined size by using depletion-induced flocculation that has been mainly applied to micrometer-sized colloids.

As used herein, the term “two-dimensional nanocube self-assembly” refers to a self-assembly composed of nanocubes formed in a monolayer two-dimensional structure. The conventional art encountered difficulties in forming two-dimensional self-assemblies due to the challenge in controlling the directionality of nanocube self-assembling, whereas the present invention facilitates the formation of a two-dimensional nanocube self-assembly by controlling the depletion force of self-assembly formation substrate-nanocube unit through a depletion-induced flocculation mechanism. As used herein, the term “three-dimensional nanocube self-assembly” refers to a self-assembly composed of nanocubes forming supercrystals in a multilayer three-dimensional structure with three or more layers.

In the present invention, a metal of the metal nanocube may be for example a noble metal. Specifically, the metal may be a material exhibiting localized surface plasmon resonance. More specifically, the metal may be for example gold (Au), silver (Ag), palladium (Pd), platinum (Pt), copper (Cu), aluminum (Al), lead (Pb), or a combination thereof, but is not limited thereto. More specifically, the metal may be gold, silver, or a combination thereof. In an example of the present invention, metal nanocubes were manufactured using gold and silver, which are representative noble metals.

Hereinafter, the present invention will be described in detail.

The method for preparing a two-dimensional or three-dimensional nanocube self-assembly of the present invention may further include, before step (a), a metal nanocube unit preparation step of preparing metal nanocubes, which are units for a metal nanocube self-assembly. Particularly, the metal nanocubes may be obtained commercially and used as they are or after surface modification, or may be prepared by a nanocube synthesis method known in the art, but are not limited thereto.

In an embodiment, the metal nanocube unit preparation step may be a metal nanocube unit synthesis step in which metal nanoparticles as seed particles are synthesized and grown to metal nanocubes, which are units of the self-assembly. Particularly, the synthesis of the metal nanocube units is not limited so long as metal nanocubes capable of serving as units for a two-dimensional or three-dimensional nanocube self-assembly finally produced by the preparation method of the present invention are synthesized.

In the present invention, metal nanoparticles have an average diameter of 0.1 nm to 30 nm. Specifically, the average diameter of the metal nanoparticles may be 0.5 to 5 nm, 1 to 5 nm, and more specifically, 1 to 2 nm, but is not limited thereto. The metal nanoparticles may be CTAC-capped gold nanospheres, but are not limited thereto. Furthermore, the metal nanoparticles may be obtained commercially and used as they are or after surface modification, or may be manufactured by a nanoparticle synthesis method known in the art, but are not limited thereto.

As one example, in the preparation method of the present invention, a combination of two or more kinds of metal nanoparticles may be used as seed particles, enabling the preparation of a metal nanocube self-assembly with a mixture of two or more kinds of nanoparticles.

In an embodiment, in the metal nanocube unit synthesis step, a solution comprising metal nanoparticles may be mixed with a precursor solution comprising a reducing agent and metal ions to grow metal nanocubes.

As one example, the solution comprising metal nanoparticles may further contain a surfactant (hereinafter referred to as a first surfactant) and a surface-protecting agent.

As used herein, the term “first surfactant” refers to a material that adsorbs to the interface in a dilute solution to reduce its surface tension, and specifically, the term may mean a molecule that can be used in step (a) to prevent the aggregation of metal nanoparticles used as seeds in a reaction solution. For example, the first surfactant may be hexadecyltrimethylammonium chloride (CTAC), but is not limited thereto, and any surfactant known in the art may be used without limitation so long as the surfactant can serve as the first surfactant defined above.

As used herein, the term “surface-protecting agent” refers to a material that selectively binds to a specific surface of a metal nanocube to adjust the crystal growth on the corresponding surface, thus controlling the shape of a final product. Specifically, the surface-protecting agent may be an organic salt of bromine, such as hexadecyltrimethylammonium bromide (CTAB), or a metal salt of bromine, such as NaBr, KBr, MgBr₂, or CaBr₂, but is not limited thereto, and any surfactant known in the art may be used without limitation so long as the surfactant can serve as the surface-protecting agent defined above.

As one example, the precursor solution comprising metal ions may be an aqueous HAuCl₄ solution, but is not limited thereto.

As one example, the precursor solution comprising metal ions may further contain a reducing agent.

As used herein, the term “reducing agent” may refer to a reagent that can reduce metal ions to grow crystals. For example, the reducing agent may be ascorbic acid, but is not limited thereto.

The metal nanocube unit synthesis according to an embodiment of the present invention has been described as the above metal nanocube unit preparation step, but one embodiment has confirmed that the preparation method of the present invention is not limited to the size and shape of metal nanocube units, and thus the present invention is not limited to the above embodiments, and the sources and methods of acquisition are not limited so long as metal nanocube units capable of forming the two-dimensional or three-dimensional nanocube self-assembly of the present invention are prepared.

First, in step (a), a first solution comprising a surfactant (hereinafter referred to as a second surfactant) and a depletant and a second solution comprising metal nanocubes are applied to a self-assembly formation substrate. Hereinafter, the first solution and the second solution together are referred to as a self-assembly formation solution. Through step (a), the metal nanocube units are subjected to binding-aggregation on the self-assembly formation substrate and then aging through step (b), which is described later, thereby forming a two-dimensional or three-dimensional self-assembly.

The preparation method of the present invention is characterized in that the dimension and structure of a formed nanocube self-assembly can be controlled by regulating depletion force of the self-assembly formation substrate-metal nanocube unit, in step (a).

The first solution in step (a) contains a second surfactant and a depletant, and can serve to induce depletion-inducing flocculation by acting on the nanocube units and the self-assembly formation substrate, together with the second solution to be described later.

As used herein, the term “second surfactant” refers to a material that adsorbs to the interface in a dilute solution to reduce its surface tension, and specifically, the term may mean a material that can be used in step (a) to prevent the aggregation of metal nanocubes. Particularly, the second surfactant is positively charged and thus may cause electrostatic repulsion with the positively charged metal nanocube units, so that the second surfactant may serve to weaken the metal nanocube unit-self-assembly formation substrate surface depletion force, or conversely, the second surfactant may be adsorbed to the surface to enhance the attraction between surfaces.

Specifically, the second surfactant may be hexadecyltrimethylammonium bromide (CTAB), but is not limited thereto, and any surfactant known in the art may be used without limitation so long as the second surfactant can serve as the second surfactant defined above.

Specifically, in step (a), optionally, the second surfactant may not be contained in the self-assembly formation solution, and the second surfactant may be contained at a concentration of specifically 0 mM to 30 mM, more specifically 0.001 mM to 10 mM, and still more specifically 0.1 mM to 1 mM, but is not limited thereto.

As used herein, the term “depletant” refers to a material that can induce the depletion-induced flocculation of metal nanocubes to form a nanocube self-assembly. The depletant exists as micelles in a solution, and when the depletant reaches the critical micelle concentration or higher to create conditions capable of inducing depletion-induced flocculation even at room temperature, the depletant allows metal nanocubes to aggregate. Specifically, the depletant may be benzyldimethylhexadecylammonium chloride (BDAC), but any organic material that can form micelles can be used without limitation.

The concentration of the depletant introduced in step (a) may be adjusted according to the size and shape of nanocubes. Particularly, the creation of an appropriate depletion force through the adjustment of the concentration of the depletant is one of the important factors in the formation of a high-purity two-dimensional or three-dimensional nanocube assembly.

Specifically, in step (a), the depletant may be contained in the self-assembly formation solution such that the concentration of the depletant is adjusted to a value inversely proportional to a value of (EL-2CR)². As used herein, the term “EL” denotes the edge length of a formed nanocube unit, and the term “CR” denotes the corner radius of a formed nanocube unit. Particularly, EL and CR may be defined as the shortest distance from one point on one flat surface of the metal nanocube to the other surface parallel thereto and as the radius of a circle that perfectly matches the corner curvature, respectively.

The depletant may be contained at a concentration of, more specifically ((41²/A²)×55)×0.7 mM to ((41²/A²)×55)×1.3 mM, and still more specifically, ((41²/A²)×55)×0.8 mM to ((41²/A²)×55)×1.2 mM, relative to the self-assembly formation solution. Particularly, the symbol A denotes a value of EL-2CR (nm), and EL and CR are as described above. If the depletant is contained at a concentration less than the above concentration range, the formation of a metal nanocube self-assembly may not be smooth, and if the depletant is contained at a concentration exceeding the above concentration range, the purity of a formed metal nanocube self-assembly may be significantly reduced.

In the present invention, the second solution in step (a) serves as a material for forming the metal nanocube self-assembly and contains metal nanocube units. The second solution comprising metal nanocube units may be added at an appropriate amount according to the metal nanocube self-assembly to be finally prepared, but is not limited thereto.

Specifically, in step (a), the metal nanocubes contained in the second solution may be composed of the same kind of metal nanoparticles or a mixture of two or more kinds of metal nanoparticles. The preparation method of the present application enables the formation of a two-dimensional or three-dimensional nanocube self-assembly on the basis of depletion-induced flocculation between nanocube units or between nanocube units and a self-assembly formation substrate, so that the present method has no limitation in the preparation of a self-assembly in which several kinds of metal nanoparticles with different chemical compositions are mixed, unlike a conventional ligand-based self-assembly preparation method that was difficult to apply several compositions due to the importance of surface composition. As one example, a nanocube self-assembly with a variably adjustable ratio of two or more kinds of metals can be formed. Specifically, the metal nanocubes may be a mixture of gold nanocubes and silver nanocubes, but is not limited thereto.

Specifically, the second solution may selectively contain a small amount of a surfactant (hereinafter referred to as a third surfactant) for stability of particles. The third surfactant may be the same or different kind from the second surfactant, and for example, the third surfactant may be hexadecyltrimethylammonium bromide (CTAB), but is not limited thereto. Specifically, the third surfactant may be contained at a concentration of 0.001 to 0.2 mM, but is not limited thereto.

As used herein, the term “self-assembly formation substrate” refers to a surface on which metal nanocubes as units are self-assembled and a two-dimensional/three-dimensional nanocube self-assembly as a final product is formed.

In the preparation method of the present invention, the regulation of the metal nanocube unit-self-assembly formation substrate depletion force may be adjusting the surface roughness of the self-assembly formation substrate. One example of the present invention verified that the structure of a finally formed nanocube self-assembly is differently controlled to be either two-dimensional or three-dimensional by varying the surface roughness of the self-assembly formation substrate.

As used herein, the term “surface roughness” refers to irregular protrusions and depressions formed on the surface of a material and having a short period and relatively small amplitude, and is defined as a center line average roughness (Rₐ). The term is understood to mean the degree of flatness of the material surface, or the opposite meaning of evenness. The surface roughness (Ra), unless otherwise specified, may be understood as a value when measurement is conducted for an area of 1 μm×1 μm in air at room temperature by using a scanning probe microscope.

Specifically, when a substrate with a relatively small surface roughness is used as the self-assembly formation substrate in step (a), the depletion-induced flocculation between the metal nanoparticle units and the surface of the self-assembly formation substrate is enhanced, leading to the formation of a monolayer two-dimensional nanocube self-assembly.

More specifically, the substrate with a small surface roughness may be a substrate with a surface roughness of less than 0.12 nm, and more specifically, a substrate with a surface roughness in the range of one upper limit and/or lower limit selected from the group consisting of 0 nm, 0.01 nm, 0.02 nm, 0.03 nm, 0.04 nm, 0.05 nm, 0.06 nm, 0.07 nm, 0.08 nm, 0.09 nm, 0.1 nm, and 0.11 nm. The use of a self-assembly formation substrate with a surface roughness within such a range can enhance the self-assembly formation substrate-unit depletion force, leading to the formation of a monolayer two-dimensional nanocube self-assembly.

Still more specifically, the substrate with a small surface roughness may be one selected from the group consisting of a silicon wafer, a metal-deposited substrate, and mica, but any material that can perform the same function due to a small surface roughness may be used without limitation.

Specifically, when a substrate with a large surface roughness is used as the self-assembly formation substrate in step (a), the depletion-induced flocculation between the metal nanoparticle units and the surface of the self-assembly formation substrate is weakened, leading to the formation of a multilayer supercrystal three-dimensional nanocube self-assembly.

More specifically, the substrate with a large surface roughness may be specifically a substrate with a surface roughness of 0.12 nm or higher and 1.2 nm or less, and more specifically, a substrate with a surface roughness in the range of one upper limit and/or lower limit selected from the group consisting of 0.12 nm, 0.2 nm, 0.3 nm, 0.4 nm, 0.5 nm, 0.6 nm, 0.7 nm, 0.8 nm, 0.9 nm, 1.0 nm, and 1.1 nm. When the substrate with a large surface roughness is used as a self-assembly formation substrate, a supercrystal three-dimensional nanocube assembly can be formed. Particularly, if the surface roughness is less than 0.12 nm, a three-dimensional self-assembly may not be formed since the depletion force between the self-assembly formation surfaces is enhanced. On the other hand, if the surface roughness is excessively large to 1.2 nm or more, neither two-dimensional nor three-dimensional self-assembly may not be formed since the depletion force may be extremely weakened.

More specifically, the substrate with a surface roughness of 0.12 nm or higher and 1.2 nm or less may be one selected from the group consisting of glass and a quartz slide, but any material that can perform the same function due to a large surface roughness may be used without limitation.

In the present invention, step (a) may selectively further include an ultrasonication step of washing the self-assembly formation substrate through ultrasonication, before the application of the first solution and the second solution to the surface of the self-assembly formation substrate. The ultrasonication step enables the removal of foreign materials on the self-assembly formation substrate.

Specifically, the ultrasonication may be performed using acetone, ethanol, distilled water (DW), or a combination thereof, but is not limited thereto.

In step (a), the first solution comprising a second surfactant and a depletant and the second solution comprising metal nanocubes may be applied to the self-assembly formation substrate simultaneously, sequentially, or at different times. One example of the present invention verified that the simultaneous application of the first solution and the second solution to the self-assembly formation substrate resulted in an increase in the number of layers in the self-assembly, and the application of the first solution to the self-assembly formation substrate, followed by a time for surfactant adsorption, and then the application of the second solution resulted in a decrease in the number of layers in the self-assembly.

Therefore, in an embodiment, the preparation method of the present invention is characterized in that the height of a three-dimensional nanocube self-assembly can be adjusted by varying the sequence and time of application of the first and second solutions in step (a).

Specifically, in step (a), the first solution comprising a second surfactant and a depletant and the second solution comprising metal nanocubes may be applied to the self-assembly formation substrate simultaneously. Particularly, step (a) may include sufficiently stirring the first solution and the second solution. In such a situation, the time for the second surfactant to be adsorbed to the self-assembly formation substrate is reduced, so that the height of a finally formed nanocube self-assembly may be five to ten layers, specifically six to eight layers.

Specifically, in step (a), the first solution may be first applied to the self-assembly formation substrate, followed by a predetermined time, and then the second solution may be applied thereto. The predetermined time, that is, the time of adsorption of the surfactant may be 0.01 to 20 hours, but is not limited thereto. In such a situation, the time for the second surfactant to be adsorbed to the self-assembly formation substrate before the application of nanocubes to the substrate increases, so that the height of a finally formed nanocube self-assembly may be as low as two to four layers, specifically, two to three layers, and the time for formation of the self-assembly can be shortened than when the first solution and the second solution are simultaneously formed on the substrate.

Then, step (b) is a self-assembly formation step where aging is performed so that the metal nanocubes assemble to form a two-dimensional or three-dimensional nanocube self-assembly. Particularly, through sufficient aging, the nanocube self-assembly is grown and self-assembling is made through depletion-induced flocculation between a unit and a unit and between a unit and a substrate, thereby finally forming a two-dimensional or three-dimensional nanocube self-assembly.

Specifically, the aging in step (b) may be performed in high humidity. More specifically, the humidity (RH) may be 20-100%, and the high humidity conditions as above need to be ensured to maintain a liquid state during the aging time and prevent the drying of the self-assembly formation solution, thereby maintaining an appropriate concentration of the second surfactant for the depletion effect, resulting in the smooth formation of a nanocube self-assembly.

Specifically, the time for aging in step (b) may be in the range of 0.25 hours or more and 14 hours or less, more specifically in the range of one upper limit and/or lower limit selected from the group consisting of 1 hour, 2 hours, 3 hours, 4 hours, 5 hours, 6 hours, 7 hours, 8 hours, 9 hours, 10 hours, and 11 hours, and more specifically, 2 hours to 8 hours. Particularly, if the aging time increases to 12 hours or longer, the quality of the nanocube self-assembly may deteriorate, due to the precipitation of by-products and drying of solutions. If the aging time is shortened to less than 2 hours, regular nanogaps may not be formed and nanocubes may aggregate randomly, and a nanocube self-assembly may not grow to a sufficient size.

Specifically, the aging in step (b) may be performed at room temperature, but is not limited thereto.

The method for preparing a two-dimensional or three-dimensional nanocube self-assembly of the present invention may selectively further include a drying step of drying the nanocube self-assembly formed after step (b). Specifically, the drying step may be performed under a nitrogen atmosphere, but any drying manner that can be commonly used in the art is not limited.

The method for preparing a two-dimensional or three-dimensional nanocube self-assembly of the present invention may selectively further include an obtaining step of obtaining the nanocube self-assembly formed after step (b).

The preparation method of the present invention can provide a two-dimensional or three-dimensional nanocube self-assembly with regular nanogaps and high crystallinity through the formation of a self-assembly in a depletion-induced flocculation manner as described above.

As used herein, the term “nanogap” may refer to the distance between a nanocube unit and an adjacent nanocube unit.

Specifically, the two-dimensional or three-dimensional self-assembly may have a uniform and regular arrangement.

Specifically, the nanocube self-assembly may have nanogaps of average 1 to 10 nm, and more specifically, nanogaps in the range of one upper limit and/or lower limit selected from the group consisting of average 1 nm, 1.5 nm, 2.0 nm, 2.5 nm, 3.0 nm, 3.5 nm, 4.0 nm, 4.5 nm, 5.0 nm, 5.5 nm, 6.0 nm, 6.5 nm, 7.0 nm, 7.5 nm, and 8.0 nm.

Specifically, the size of the nanocube unit in the nanocube self-assembly may be 1 to 300 nm, for example, 30 to 80 nm, but it should be understood that the preparation method of the present invention is not limited to the size of the nanocube units in view of achieving the purpose.

Specifically, the nanocube self-assembly may have a monolayer two-dimensional structure.

Specifically, the nanocube self-assembly may have a multi-layer supercrystal three-dimensional structure. More specifically, the nanocube self-assembly may be formed with a height of three to eight layers when the nanocube self-assembly has a three-dimensional self-assembly.

The preparation method of the present invention can provide a millimeter-scale self-assembly where micrometer-level nanocube units aggregate each other, and thus the present invention is highly applicable to other fields. As one example, the size of the nanocube self-assembly formed by the preparation method of the present invention may be 0.1-50 μm, and more specifically 0.3-20 μm, but is not limited thereto.

In accordance with another aspect of the present application, there is provided a two-dimensional or three-dimensional nanocube assembly produced by the method for preparing a two-dimensional or three-dimensional nanocube self-assembly.

Particularly, the metal, two-dimensional nanocube self-assembly, three-dimensional nanocube self-assembly, and method for preparing a nanocube self-assembly are defined as described above.

In accordance with another aspect of the present application, there is provided a composition for forming a two-dimensional or three-dimensional nanocube self-assembly, the composition including a first solution comprising a surfactant and a depletant, a second solution comprising metal nanocubes, and a self-assembly formation substrate.

The first solution, second solution, metal, metal nanocube units, self-assembly formation substrate, and nanocube self-assembly are defined as described above.

### Advantageous Effects

The preparation method of the present invention can simply ensure a two-dimensional or three-dimensional nanocube self-assembly with uniform and regular nanogaps as a final product by dispersing structurally precisely controlled units in a solution comprising a depletant and changing the characteristics of a self-assembly formation substrate, even without a complex process as in a top-down method or additional surface modification of units as in a conventional bottom-up method using DNA or electrostatic attraction. This precise control of units enables the control of optical characteristics of the self-assembly, and the nanogaps and high crystallinity of the self-assembly can be utilized as stable optical signal amplifiers.

### BRIEF DESCRIPTION OF DRAWINGS

FIG. 1 shows electron microscopy images of massively synthesized gold nanocubes in the range of 30 to 200 nm.

FIG. 2 schematically shows the formation processes of two-dimensional and three-dimensional nanocube self-assemblies in one example of the present invention, depicting the process of forming a two-dimensional self-assembly on a silicon wafer (right upper) and the procedure of forming a three-dimensional self-assembly on glass (right lower).

FIG. 3 shows two-dimensional self-assemblies formed of cubes with different sizes and sharpnesses. Specifically, FIG. 3A shows two-dimensional self-assemblies formed of nanocubes with different sizes, and FIG. 3B shows two-dimensional self-assemblies formed of cubes with different sharpnesses.

FIG. 4 shows SEM images with different magnifications of a two-dimensional self-assembly (left) and a three-dimensional nanocube self-assembly (right) prepared in one example of the present invention.

FIG. 5 shows atomic force microscope (AFM) results of the three-dimensional nanocube self-assembly of FIG. 4.

FIG. 6 shows the UV-Vis extinction tracking results of solutions comprising nanoparticles in a two-dimensional nanocube self-assembly and a three-dimensional nanocube self-assembly prepared in one example of the present invention.

FIG. 7 shows the formation of self-assemblies over time measured under a microscope.

FIG. 8 shows the AFM results of observing the surface structures of a silicon wafer and glass.

FIG. 9 shows the formation of gold nanocube self-assemblies using an Au film and a quartz substrate with a large surface roughness due to mechanical cutting.

FIG. 10 shows the results of forming a nanocube self-assembly when the surface roughness of a silicon wafer was increased to about 1.2 nm.

FIG. 11 shows the structures of nanocube self-assemblies formed when a first solution and a second solution were simultaneously applied on a substrate and when a first solution was applied, followed by a predetermined time, and then a second solution was applied.

FIG. 12 shows, through BSE mode imaging, the shape of a two-dimensional nanocube assembly prepared by mixing gold nanocube particles (AuNC) and silver nanocube particles (AgNC).

### DETAILED DESCRIPTION OF THE INVENTION

Hereinafter, the present invention will be described in detail through examples. These examples are given for specifically illustrating the present invention, and the scope of the present invention is not limited thereto.

### Example 1: Synthesis of Nanocubes

### Example 1-1: Synthesis of Seed Particles

A solution of 1-2 nm-diameter Au nanospheres was prepared by mixing 100 mM cetyltrimethylammonium bromide (CTAB), 10 mM HAuCl₄, and 10 mM NaBH₄. In the corresponding procedure, CTAB, NaBH₄, and HAuCl₄ were used as a first surfactant, a reducing agent, and metal ions, respectively.

A solution of 10 nm-diameter nanospheres was prepared by mixing 200 mM cetyltrimethylammonium chloride (CTAC), 100 mM ascorbic acid, the solution of 1-2 nm diameter Au nanospheres, and 0.5 mM HAuCl₄, and purified by centrifugation. In the corresponding procedure, CTAC, ascorbic acid, HAuCl₄, and 1-2 nm diameter Au nanospheres were used as a first surfactant, a reducing agent, metal ions, and seed particles, respectively.

### Example 1-2: Synthesis of Au Nanocube Units

Gold nanocubes were synthesized by mixing CTAC, sodium bromide (NaBr), the solution of 10 nm-diameter nanospheres, ascorbic acid, and HAuCl₄. In the corresponding procedure, CTAC, ascorbic acid, HAuCl₄, NaBr, and 10-nm-diameter Au nanospheres were used as a first surfactant, a reducing agent, a surface-protecting agent, metal ions, and seed particles, respectively.

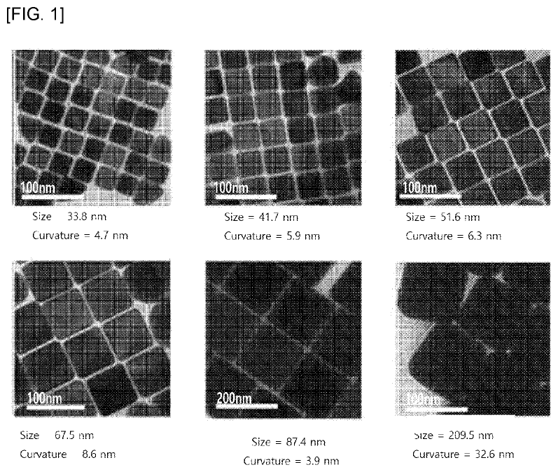

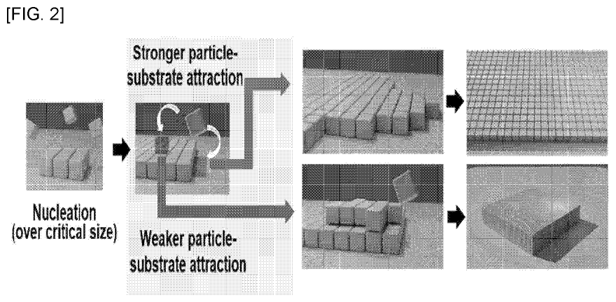

In the corresponding procedure, nanocubes, of which the size and corner sharpness index were controlled by adjusting the amount of metal ions and the amount of a surface-protecting agent, were synthesized. Images of nanocubes with various sizes synthesized in the example are shown in FIG. 1. The nanocubes of the example were synthesized using the techniques disclosed in Nano Letters, 18, 6475 (2018) and “Method for Preparing Metal Nanocubes with Controlled Corner Sharpness Index”, but nanocubes prepared by other methods could serve as units for a two-dimensional/three-dimensional self-assembly, which was a final product, and are not limited to a particular method.

### Example 2: Preparation of Two-Dimensional Nanocube Self-Assemblies

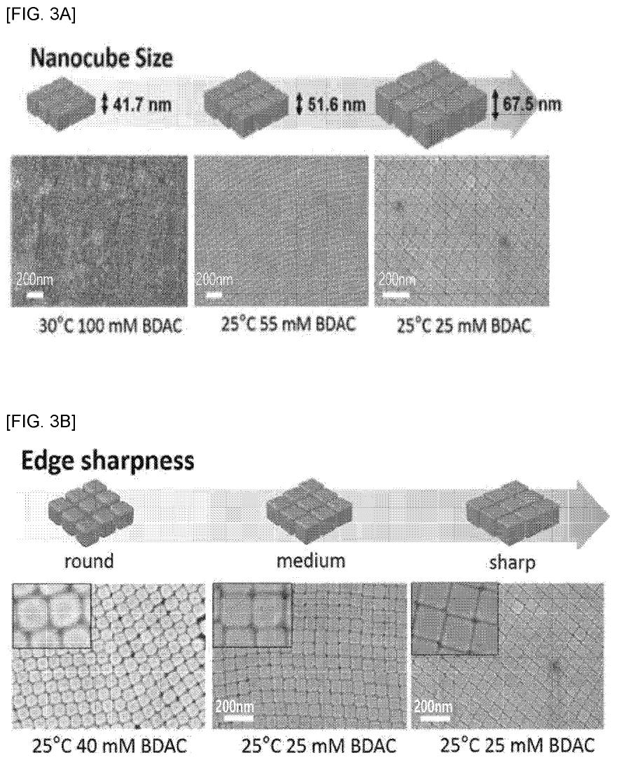

A self-assembly solution was prepared by mixing CTAB, BDAC, and a nanocube solution. The self-assembly solution was placed on a self-assembly formation substrate and aged for about three hours in the conditions of room temperature and high humidity, thereby forming a self-assembly. A silicon wafer, when used as the self-assembly formation substrate, was subjected to ultrasonication in the order of acetone, ethanol, and distilled water, and then dried with nitrogen. To investigate that the formation of a self-assembly was not limited by structural factors of the units, a self-assembly was formed by controlling the size and sharpness index. According to the above-described principle, an appropriate depletant concentration suitable for the size and shape of the nanocube units was used. Two-dimensional self-assemblies were formed on a silicon wafer by using nanocube units with various sizes and sharpnesses in the conditions shown in FIG. 3, and the floating nanocube units and second surfactant were washed with a high-concentration depletant solution.

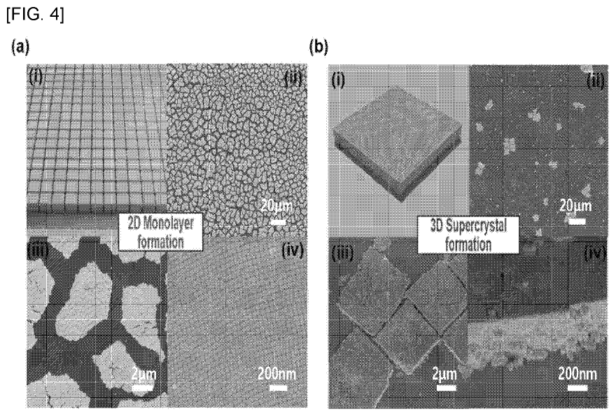

As can be seen in FIG. 3, the formation of two-dimensional self-assemblies of 41.7-nm nanocubes, 51.6-nm nanocubes, 67.5-nm nanocubes, 71-nm round nanocubes, medium-sharpness nanocubes, and 70-nm sharp nanocubes was ultimately observed. This verified that the preparation method of the present invention was applied without limitation to the size and sharpness of units even though the depletant concentration and temperature were somewhat different in each situation. It was additionally verified that about 50-nm nanocubes were formed at an interval of about 3 nm between units, with a grain size of 1-10 μm and a height of several nanometers (FIG. 4). Compared with self-assemblies obtained through nanoimprinting, the final product of the present invention was verified to retain high crystallinity.

### Example 3: Preparation of Three-Dimensional Nanocube Self-Assemblies

Glass, which was used as a self-assembly formation substrate, was subjected to ultrasonication like the silicon wafer used for the formation of the two-dimensional self-assembly. Particularly, CTAB, which was a second surfactant, had the same effect as the first surfactant, and as set forth in the above principle, CTAB was adsorbed to the nanocube units and the self-assembly formation substrate to change the surface characteristics of the self-assembly formation substrate. BDAC, which was a depletant, allows 50-nm nanocubes as units to aggregate and grow into a self-assembly. The self-assembly formation solution was placed on the surface-modified self-assembly formation substrate and subjected to aging for an appropriate time in the conditions of room temperature and high humidity, thereby forming a self-assembly.

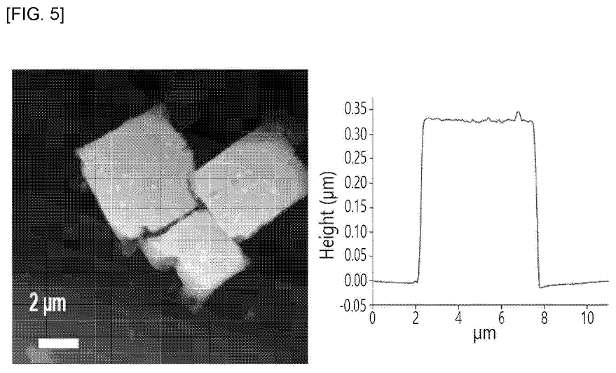

In Example 2 above where the self-assembly formation substrate was a silicon wafer, a monolayer two-dimensional nanocube self-assembly was formed under appropriate CTAB and BDAC conditions, as can be seen in FIG. 4A. In Example 3 where the self-assembly formation substrate was glass, a three-dimensional self-assembly was formed as can be seen in FIG. 4B. The formation results of the three-dimensional nanocube self-assembly are shown in FIG. 4 with an SEM image obtained by vertically observing the sample and a tilted SEM image obtained by observing the sample at a tilted angle, and are shown through AFM results of FIG. 5.

### Example 4: Formation of Two-Dimensional/Three-Dimensional Nanocube Self-Assemblies

To observe the formation procedures of two-dimensional/three-dimensional self-assemblies, the time-dependent absorbance measurement capable of indirectly measuring the rate of assembly formation and the bright-field microscopy measurement capable of directly catching the formation of three-dimensional self-assembly were conducted.

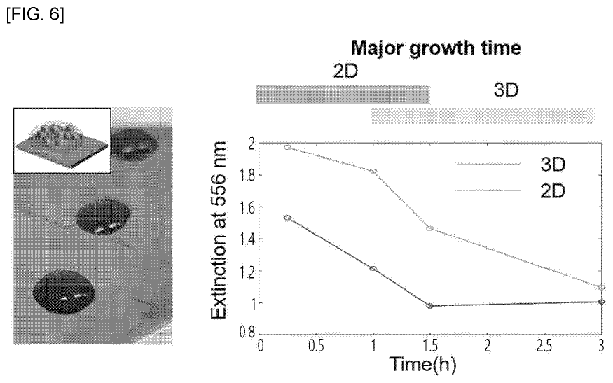

First, an absorbance measurement experiment was conducted. As the number of units involved in the formation of a self-assembly increases, the number of nanoparticles in a solution decreases, leading to a decrease in the absorbance of the solution. Therefore, the measurement of absorbance change of the self-assembly formation solution over time enables the determination of the amount of cubes constituting the self-assembly over time. In the present experiment, the relative absorbance changes were observed for self-assembly formation solutions, all of which were diluted to a predetermined ratio, and shown in FIG. 6. When two-dimensional self-assemblies were formed using a silicon wafer as a self-assembly formation substrate, most of the self-assemblies were formed within one and a half hours of the reaction. On the other hand, three-dimensional self-assemblies using glass as a self-assembly formation substrate were formed relatively slowly at the beginning and were formed more rapidly after 1 hour of the reaction.

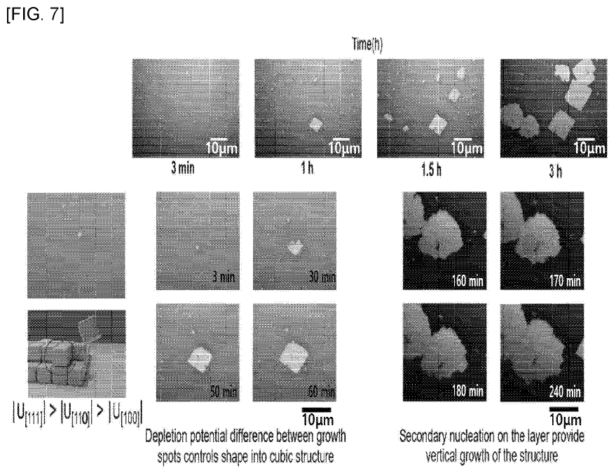

To investigate the formation of self-assemblies more directly, the formation of self-assemblies on the glass was observed under a bright-field microscope (FIG. 7). As can be seen in FIG. 7, more domains were formed after 1 hour, and these results were consistent with the UV results. The reason is that the formation of a self-assembly is divided into nucleation and growth. Compared with a particle, on a surface with nothing else, feeling only the depletion force between itself and the surface, a particle next to another particle feels a greater depletion force since the particle also feels the additional depletion force between itself and the neighboring particle. Therefore, particles aggregate more easily when there are additional particles adhering to a surface, serving as a catalyst for assembly growth. The assembly growth necessitates a particle serving as a nucleus, but the particle may be again dispersed in a solution after adhering to the surface (toggling interaction), and thus, a nucleus with a critical size needs to be formed to allow the particle to stably exist on the surface. It is thought that this nucleation for nucleus formation occurs more slowly in the formation of a three-dimensional self-assembly due to a relatively weak particle-surface depletion force than in the formation of a two-dimensional self-assembly, and such nucleation occurs at many sites after one hour of the reaction. In addition, when a depletion-induced flocculation serves as the dominant force during the growth of an assembly, the assembly predominantly takes the shape of a rectangular parallelepiped. The reason is that the depletion-induced flocculation is stronger as the newly added particles during the growth of the assembly face more sides of the assembly, and therefore, the flat sides of the assembly grow at a slow rate and the corners of the assembly grow at a fast rate, so that the flat sides ultimately occupy most of the surface area. This can be confirmed in FIG. 7 showing the observation results of corners finally disappearing. Additionally, the growing of new layers on the generated assembly could be confirmed under a bright-field microscope (FIG. 7). The formation of new nuclei on the assembly and their rapid increase in width could be confirmed by color differences under a bright-field microscope.

### Example 5: Effect of Surface Roughness

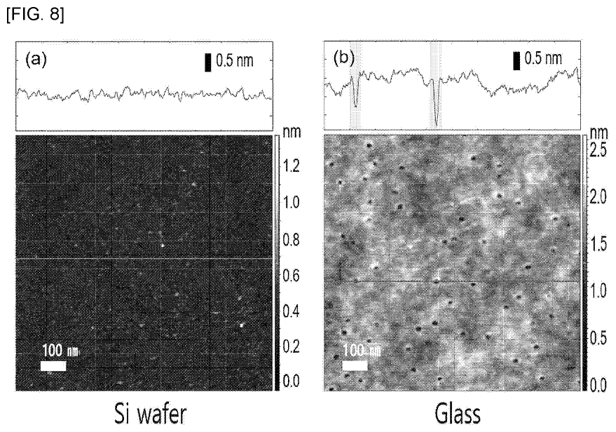

To investigate the effect of the surface characteristics of the self-assembly formation substrate on the formation of two-dimensional and three-dimensional assemblies, the surface structures of the silicon wafer for forming the two-dimensional assembly and the glass for forming the three-dimensional assembly were investigated by AFM (FIG. 8). As can be seen in FIG. 8, the roughnesses of the silicon wafer and the glass were 0.0661 nm and 0.151 nm, respectively, showing a large difference therebetween, and holes of 10-90 nm in size and about 1 nm in depth existed on the surface of the glass. It was presumed that such sporadic pores with a relatively large roughness on the glass correspond to one of the causes of the formation of a three-dimensional assembly by reducing the volume of exclusion spaces formed between nanoparticles and the surface compared with a relatively flat silicon wafer and weakening the particle-surface depletion-induced flocculation.

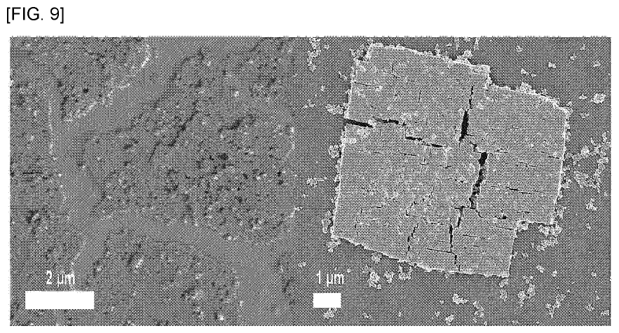

To further investigate such a principle, an Au film formed by template stripping on the Si wafer surface and a quartz substrate with a high surface roughness due to mechanical cutting were used to gold nanocube self-assemblies, and the structures of the formed self-assemblies were observed and shown in FIG. 9. As can be seen in FIG. 9, a two-dimensional nanocube self-assembly was formed on the surface of the Au film substrate (FIG. 9, left), and a three-dimensional nanocube assembly was formed on the surface of the quartz substrate (FIG. 9, right).

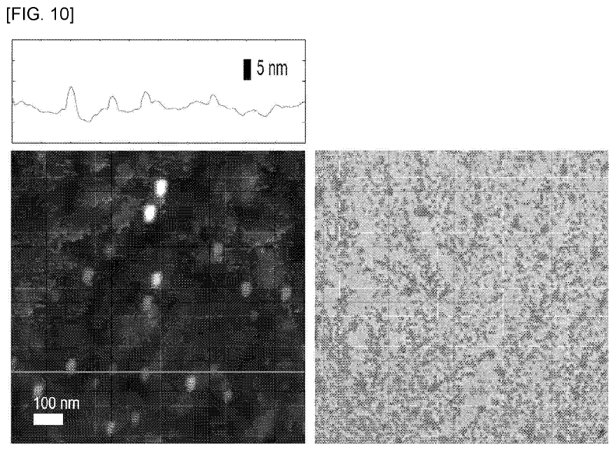

Meanwhile, the silicon wafer was roughened by treatment with a 0.01 M solution for 18 hours, resulting in a significant increase in surface roughness to approximately 1.2 nm, along with the formation of protrusions and depressions of several nanometers in height, and then an attempt was made to prepare a gold nanocube self-assembly by using the modified silicon wafer as a self-assembly formation substrate, but neither a two-dimensional nor a three-dimensional nanocube self-assembly was appropriately formed (FIG. 10). It was therefore confirmed that the upper limit of the surface roughness of a self-assembly formation substrate also needs to be appropriately adjusted for the formation of a three-dimensional nanocube assembly.

The above results confirmed that the roughness and flatness of the surface of a self-assembly formation substrate are adjusted to influence the depletion force for forming a self-assembly, thereby ultimately determining the dimension and structure of the formed nanocube self-assembly.

### Example 6: Effect of Surfactant Adsorption Time

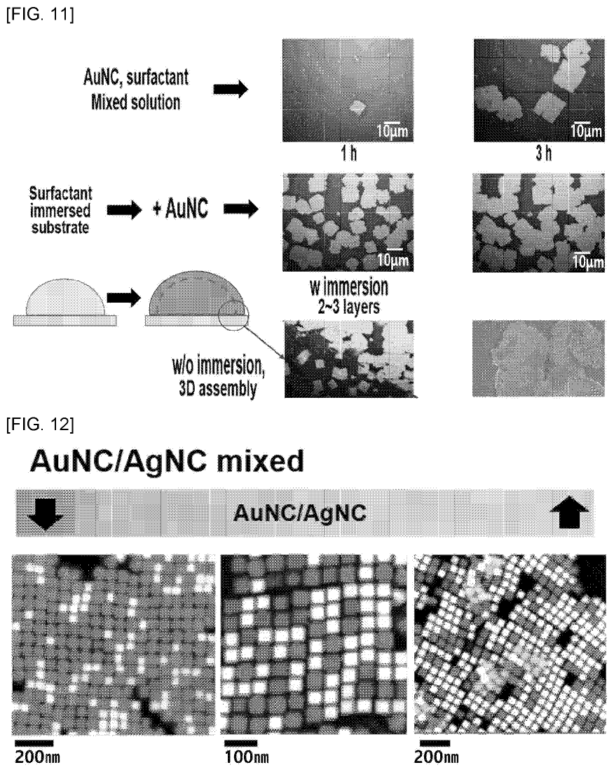

In the conditions where a three-dimensional structure was formed, two methods were individually performed and the results were compared and shown (FIG. 11), wherein one method was performed by mixing an existing self-assembly formation solution and a nanocube solution and placing the solutions on a self-assembly formation substrate at once, and the other method was performed by first placing a self-assembly formation solution comprising BDAC and CTAB on a self-assembly formation substrate, followed by a predetermined time, and then adding a solution comprising nanoparticles.

Regarding the method of mixing nanoparticles and BDAC and CTAB solutions and placing the mixture and the method of first placing BDAC and CTAB, followed by a predetermined time, and then adding nanoparticles, the former method resulted in a self-assembled structure measuring six to eight cubes in height, and the latter method resulted in a low self-assembled structure measuring two to three cubes in height, which was formed relatively quickly and showed high coverage. It was presumed that the surfactants, such as BDAC and CTAB, which were adsorbed to the self-assembly forming substrate at an interval of a predetermined time before the addition of nanoparticles, affected the formation of the assembly to produce a different product from the existing results obtained without the surfactant adsorption time.

### Example 7: Preparation of Two-Dimensional Self-Assembly with Mixed Different Types of Nanocubes

The depletion-induced flocculation-based nanocube self-assembly of the present invention is formed mainly depending on the size and shape of particles, not the chemical composition or characteristics of particles. Therefore, the present invention is expected to have no limitations in the formation of an assembly with a mixture of various types of nanoparticles with different chemical compositions, unlike the existing ligand-based method, which was difficult to apply to various compositions since the surface composition was known to be important. To investigate such presumption, self-assembly formation solutions where gold nanocube particles and silver nanocube particles with similar sizes were mixed at different ratios were prepared to form two-dimensional self-assemblies.

The nanocube particles obtained in Example 2 were used as gold nanocube particles, and silver nanocube particles were obtained through the following procedure. Ag seed particles were synthesized, and mixed with 25 μL of 200 mM CTAC and 9.975 mL of distilled water. Then, 25 μL of 100 mM AgNO₃ was added. Immediately after AgNO₃ was inserted, 0.45 mL of 20 mM NaBH₄ was added at once time, and then the mixture was left at 30° C. for 40 minutes. Through a seed growth method, 60-nm Ag nanocubes were formed. Thereafter, 1 mL of 200 mM CTAC, 7.8 mL of distilled water, 0.1 ml of pre-synthesized seed particles, 1 mL of 100 mM AgNO₃, and 1 mL of 100 mM AA were sequentially added with mixing at 60° C. After incubation at 60° C. for 3 hours, the particles were washed twice with distilled water by using centrifugation, and dispersed in a final volume of 3 mL. A depletion-induced flocculation step was performed to remove nanowires from the solution. Though mixing of 0.95 mL of a nanoparticle solution, 1.15 mL of distilled water, and 900 μL of 100 mM BDAC, a final BDAC concentration of 30 mM was made. The solution was incubated overnight at 25° C. without disturbance, and the supernatant was carefully collected, washed twice in centrifugation, and finally re-dispersed in 1 mL.

Gold nanocube particles and silver nanocube particles were obtained by the above procedure, and applied on the surface of a self-assembly formation substrate by the same method as in Example 3, thereby forming a two-dimensional self-assembly (FIG. 12). As the gold/silver ratio in the solution phase increased, the proportion of gold nanoparticles in the formed self-assembly increased, and therefore, it can be seen that the preparation method of the present invention enables the formation of self-assemblies having different ratios of various nanoparticles with different compositions by simply mixing the nanoparticles at adjusted ratios.

While the present invention has been described with reference to the particular illustrative embodiments, a person skilled in the art to which the present invention pertains can understand that the present invention may be embodied in other specific forms without departing from the technical spirit or essential characteristics thereof. Therefore, the embodiments described above should be construed as being exemplified and not limiting the present invention. The scope of the invention should be construed that the meaning and scope of the appended claims rather than the detailed description and all changes or variations derived from the equivalent concepts fall within the scope of the present invention.

### INDUSTRIAL APPLICABILITY

The present invention can be applied to various fields. such as physics, chemistry, materials, and electronics and is based on highly economical nanotechnologies. The nano fusion technology market in Korea exceeded KRW 140 trillion in 2017, and the global nanotechnology market is expected to grow at an average annual rate of 17% by 2024, owing to the wide range of uses of nanotechnology. More specifically, the present invention can be applied to a nano-process market targeting nano-level structure control or a nanosensor market using optical characteristics of nanogaps. Furthermore, when utilized in biosensors detecting biomaterials, the present invention is expected to be actively applied to diagnostic and health care markets, which are receiving much attention and are expanding significantly due to the spread of COVID-19 and the increase in average life expectancy.

1. A method for preparing a two-dimensional or three-dimensional self-assembly, wherein the dimension and structure of a nanocube self-assembly formed by controlling the depletion force of the self-assembly formation substrate-unit, the method comprising:
(a) applying, to a self-assembly formation substrate, a first solution comprising a surfactant and a depletant and a second solution comprising metal nanocube units; and
(b) performing aging so that the metal nanocubes assemble to form a two-dimensional or three-dimensional nanocube self-assembly.

2. The method of claim 1, wherein in step (a), a monolayer two-dimensional nanocube self-assembly is formed when a material having a surface roughness (Rₐ) of less than 0.12 nm is used as the self-assembly formation substrate.

3. The method of claim 1, wherein in step (a), a supercrystal three-dimensional nanocube self-assembly is formed when a material having a surface roughness (Rₐ) of 0.12 nm or higher and 1.2 nm or less is used as the self-assembly formation substrate.

4. The method of claim 2, wherein the material having a surface roughness (Rₐ) of less than 0.12 nm is one selected from the group consisting of a silicon wafer, a metal-deposited surface, and mica.

5. The method of claim 3, wherein the material having a surface roughness (Rₐ) of 0.12 nm or higher and 1.2 nm or less is one selected from the group consisting of glass and a quartz slide.

6. The method of claim 1, wherein the depletant is contained at a concentration of ((41²/A²)×55)×0.7 mM to ((41²/A²)×55)×1.3 mM relative to a self-assembly formation solution including the first solution and the second solution together,
wherein A denotes a value of EL-2CR (nm), and
EL denotes the edge length defined as the shortest distance from one point on one flat surface of the metal nanocube to the other surface parallel thereto, and CR denotes the corner radius defined as/of a circle that perfectly matches the corner curvature.

7. The method of claim 1, wherein the metal is gold (Au), silver (Ag), palladium (Pd), platinum (Pt), copper (Cu), aluminum (Al), lead (Pb), or a combination thereof.

8. The method of claim 1, wherein in step (a), the first and second solutions are simultaneously applied to the self-assembly formation substrate, or the first solution is first applied to the self-assembly formation substrate, followed by a predetermined time, and then the second solution is applied.

9. The method of claim 1, wherein the aging in step (a) is performed at a high humidity of 20 to 100%.

10. The method of claim 1, wherein the time for aging in step (b) is 2 hours or more and 12 hours or less.

11. The method of claim 1, further comprising, before step (a), a metal nanocube unit synthesis step of mixing a solution comprising metal nanoparticles with a precursor solution comprising a depletant and metal ions to grow metal nanocubes.

12. The method of claim 1, wherein in the applying, the first solution comprising a surfactant and a depletant and the second solution comprising metal nanocubes are applied to the self-assembly formation substrate simultaneously, sequentially, or at different times.

13. The method of claim 1, wherein the prepared two-dimensional or three-dimensional self-assembly has an average nanogap of 1 to 5 nm.

14. The method of claim 1, wherein the prepared two-dimensional or three-dimensional self-assembly has high crystallinity.

15. The method of claim 1, wherein the prepared two-dimensional or three-dimensional self-assembly has uniform and regular nanogaps.

16. The method of claim 1, wherein the prepared two-dimensional or three-dimensional self-assembly has a size of 0.1 to 50 μm.

17. A two-dimensional or three-dimensional nanocube self-assembly prepared by the method of claim 1.
